(19) United States
(12) Patent Application Publication
(10) Pub. No.: US 2007/0234568 A1
(43) Pub. Date: Oct. 11, 2007

(54) Pipe coupling methods

(76) Inventor: Daniel J. Knoblauch, Greenfield, WI (US)

Correspondence Address: Donald J. Ersler, 725 Garvens Avenue, Bookfield, WI, 53005, US

(21) Appl. No.: 11/393,472

(22) Filed: Mar. 30, 2006

(51) Int. Cl. B23P 17/00

(52) U.S. Cl. 29/890.14

(57) ABSTRACT

A pipe coupling method includes at least one end seal, a clamping device and forming a flared end on two adjacent pipes. An internal slot is formed on both sides of the end seal to receive the flared ends of the adjacent pipes. An inner perimeter is formed through each end seal. Closing the clamping device forces the two adjacent pipes and each end seal together. A second embodiment of a pipe coupling method includes a first end seal, a second end seal, the clamping device, a tubular insert and forming a bell flare on the ends of two adjacent pipes. The first end seal is attached to a first pipe and the second end seal to a second pipe. The tubular insert is sized to be received by the inner perimeters of the two bell flares and the inner perimeters of the first and second end seals.

### BACKGROUND OF THE INVENTION

1. Field of the Invention

The present invention relates generally to coupling one pipe to another pipe and more specially to pipe coupling methods, which enable the efficient connecting of two adjacent pipes.

2. Discussion of the Prior Art

The prior art includes numerous methods of pipe coupling. Some of these prior art pipe coupling methods include U.S. Pat. No. 4,163,571 to Nash and U.S. Pat. No. 6,045,033 to Zimmerly. The Nash patent discloses pipe couplings. The Nash patent includes pipe coupling for two identical tubular parts with end flanges, by a clamping ring. However, the Nash patent requires the use of an adhesive to retain the flange on the pipe. Adhesive is not a positive way of retaining a flange on a pipe. The Zimmerly patent discloses a pipe connection and method. The Zimmerly patent includes a method of forming lengths of pipe for assembly together to form fluid flow conduits. However, the Zimmerly patent discloses the use of welding to attach a flange to an end of a pipe. A welding operation is susceptible to defects and requires human inspection to verify weld quality.

Accordingly, there is a clearly felt need in the art for pipe coupling methods, which provide a positive joint, do not require human inspection and have the efficient connecting two adjacent pipes.

### SUMMARY OF THE INVENTION

The present invention provides pipe coupling methods, which include the efficient connecting of two adjacent pipes. The pipe coupling method includes at least one end seal, a clamping device and forming a flare on the ends of two adjacent pipes. The clamping device includes a first clamp ring half, a second clamp ring half and a draw lever. One end of the first clamp ring half is pivotally attached to one end of the second clamp ring half. The cross section of each clamp ring preferably has a substantial V-shape. The other ends of the first and second clamp ring halves are drawn together by closing the draw lever. However, other designs of clamps may also be used.

It is preferable to have two end seals. However, a single end seal may be fabricated to replace the two separate end seals. One side of the end seal includes an internal slot that is sized to receive the flare on one end of a pipe. A tapered surface is also formed on the one side of the end seal. The other side of the end seal is flat. An inner perimeter is formed through each end seal that is preferably the same size as the inner perimeter of the two adjacent pipes. An inner surface of each clamp ring half is sized to receive two adjacent end seals. Closing the draw lever forces the two adjacent pipes and the at least one end seal together.

A second embodiment of a pipe coupling method includes a first end seal, a second end seal, the clamping device, a tubular insert and forming a bell flare on ends of two adjacent pipes. The bell flare includes an expansion portion and a flare. The first end seal includes an first internal slot that is sized to receive the flare of a first pipe. A first tapered surface is also formed on the one side of the first end seal. At least one seal projection extends from the other side of the first end seal. An inner perimeter is formed through the first end seal that is preferably the same size as the inner perimeter of the two adjacent pipes.

The second end seal includes a second internal slot that is sized to receive the flare on one end of a second pipe. A second tapered surface is also formed on the one side of the second end seal. An inner perimeter is formed through the second end seal that is preferably the same size as the inner perimeter of the two adjacent pipes. The tubular insert is sized to be received by the inner perimeters of the two expansion portions and the inner perimeters of the first and second end seals. An inner surface of each clamp ring half is sized to receive the first and second end seals. Closing the draw lever forces the two adjacent pipes and the end seals together.

Accordingly, it is an object of the present invention to provide pipe coupling methods, which provide a positive seal.

Finally, it is another object of the present invention to provide pipe coupling methods, which do not require human inspection.

These and additional objects, advantages, features and benefits of the present invention will become apparent from the following specification.

### BRIEF DESCRIPTION OF THE DRAWINGS

FIG. 1 is an exploded perspective view of a pipe coupling method for joining two adjacent pipes in accordance with the present invention.

FIG. 2 is a perspective view of a pipe coupling method for joining two adjacent pipes in accordance with the present invention.

FIG. 3 is a cross sectional view of a pipe coupling method for joining two adjacent pipes in accordance with the present invention.

FIG. 4 is an exploded perspective view of a second embodiment of a pipe coupling method for joining two adjacent pipes in accordance with the present invention.

FIG. 5 is a perspective view of a second embodiment of a pipe coupling method for joining two adjacent pipes in accordance with the present invention.

FIG. 6 is a cross sectional view of a second embodiment of a pipe coupling method for joining two adjacent pipes in accordance with the present invention.

### DETAILED DESCRIPTION OF THE PREFERRED EMBODIMENTS

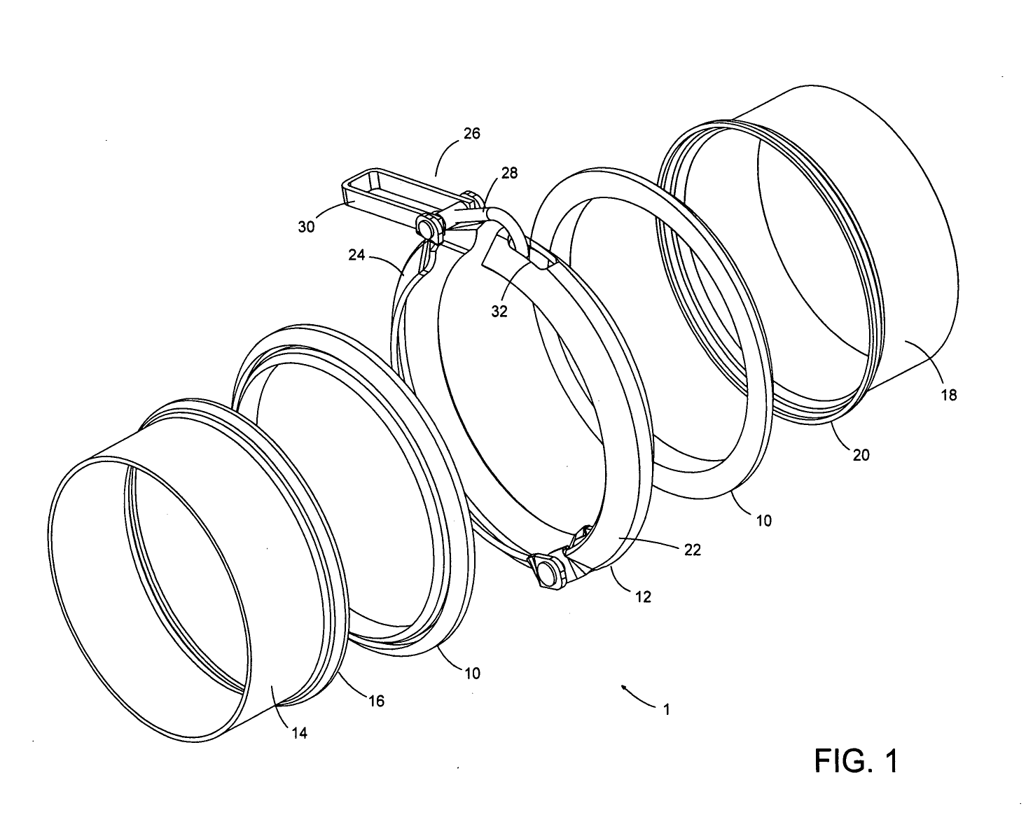

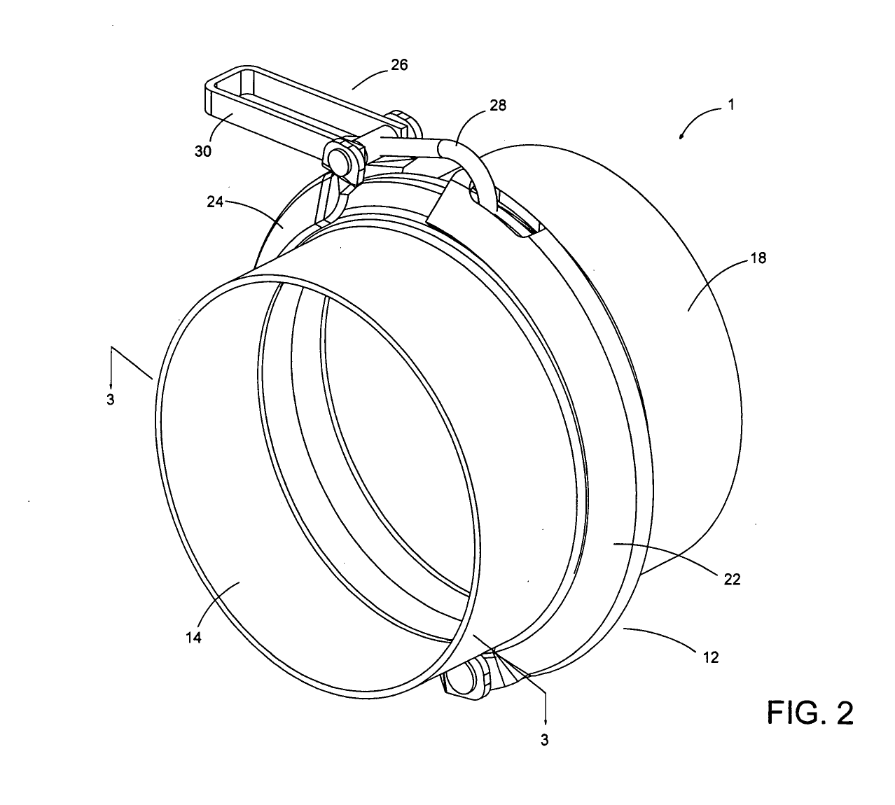

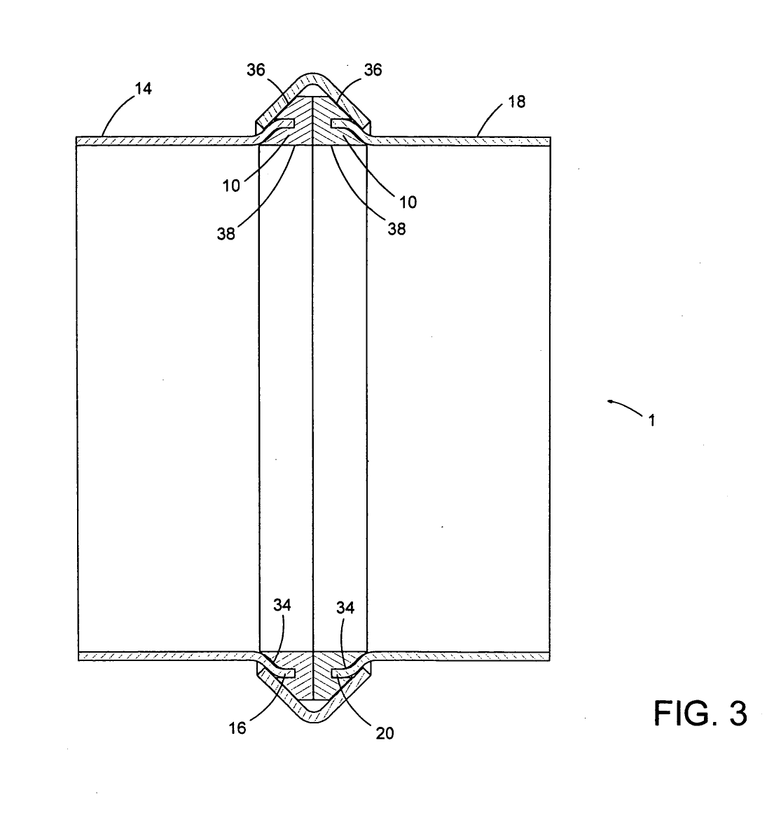

With reference now to the drawings, and particularly to FIG. 1, there is shown an exploded perspective view of a pipe coupling method 1. With reference to FIGS. 2-3, the pipe coupling method 1 includes at least one end seal, a clamping device 12, forming a first flare 16 on a first pipe 14 and forming a second flare 20 and a second pipe 18. The clamping device 12 includes a first clamp ring half 22, a second clamp ring half 24 and a draw lever 26. One end of the first clamp ring half 22 is pivotally attached to one end of the second clamp ring half 24 with any suitable method. The cross section of each clamp ring half has a substantial V-shape.

The draw lever 26 includes a pull hook 28 and a pivotal lever 30. Draw levers are well known in the art and need not be explained in detail. A hook slot 32 is formed through the other end of one of the clamp ring halves. The draw lever 26 is pivotally attached to the other end of the other clamp ring half. The other ends of the first and second clamp ring halves are drawn together by inserting the pull hook 28 into the hook slot 32 and pulling the pivotal lever 30 away from the hook slot 32. A V-clamp could be used for the clamping device 12, but other designs of clamps may also be used.

It is preferable to have two end seals 10. However, a single end seal may be fabricated to replace the two separate end seals 10. One side of the end seal 10 includes an internal slot 34 that is sized to receive the flare 16, 20 of the first or second pipe. A tapered surface 36 is also formed on the one side of the end seal 10, substantially between the internal slot 34 and an outer perimeter of the end seal 10. The other side of the end seal 10 is flat, such that it seals against a second end seal 10. An inner perimeter 38 is formed through each end seal 10, which is preferably the same size as the inner perimeter of the pipes 14, 18. An inner surface of each clamp ring half 22, 24 is sized to receive the two adjacent end seals 10 and the flanges 34 of the first and second pipes. Closing the draw lever 26 forces the first and second pipes toward each other and the end seals 10 to seal against each other.

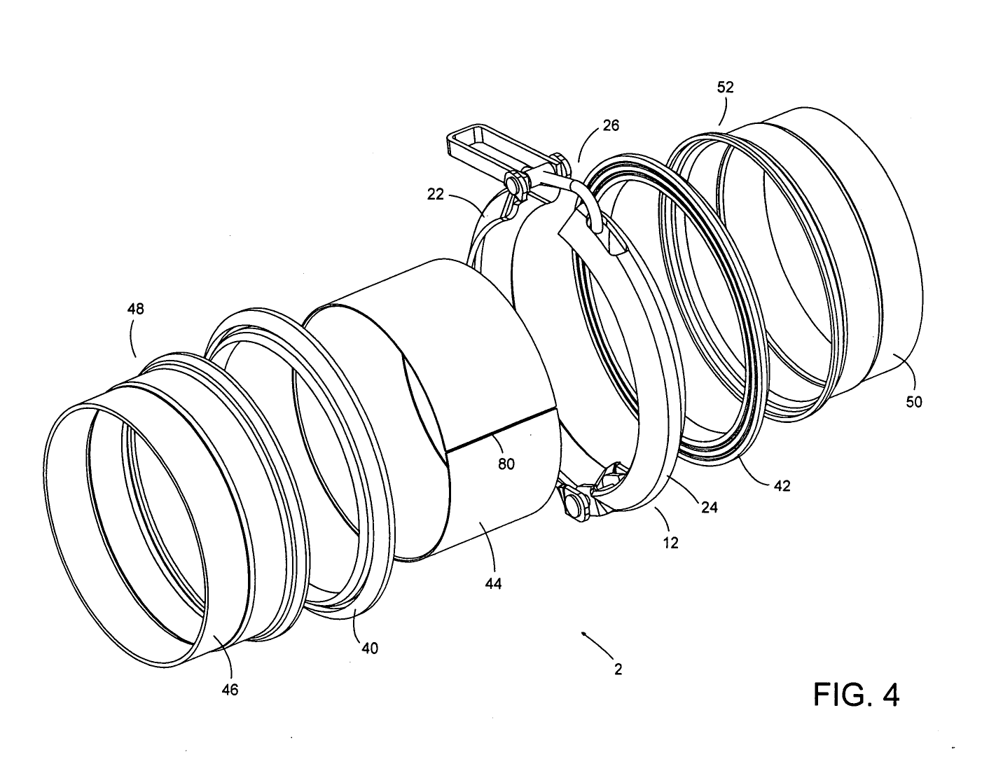

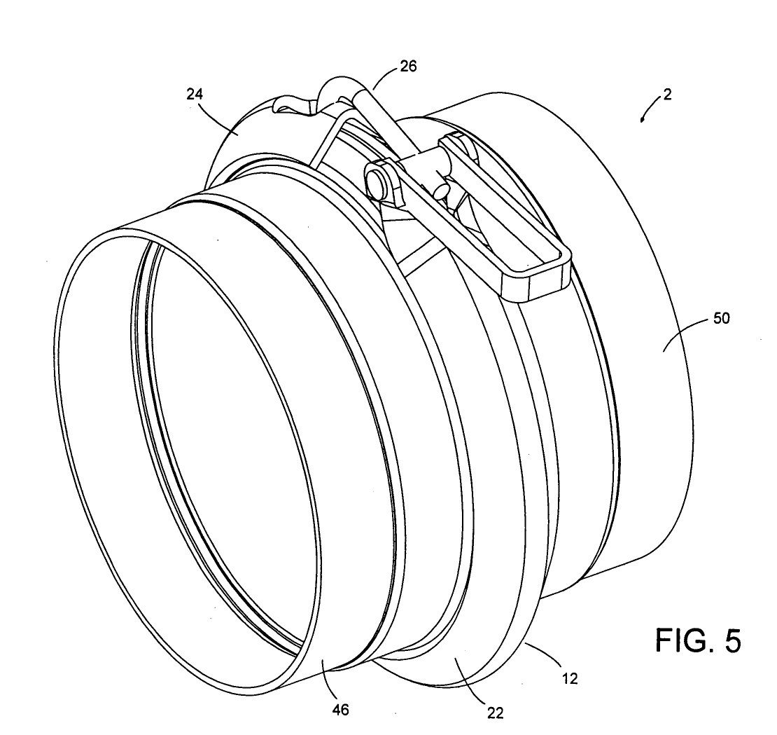

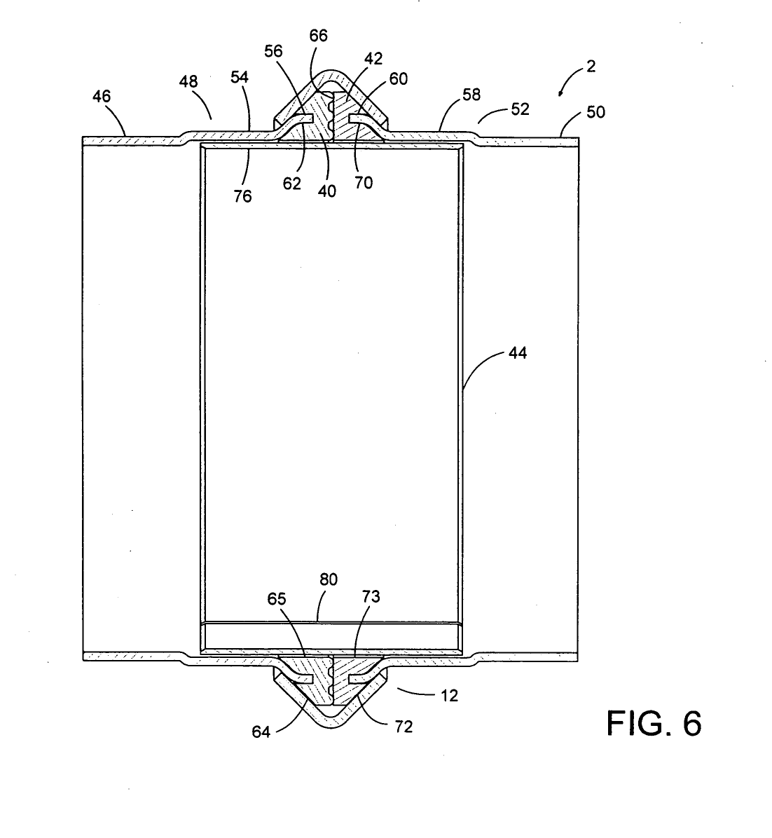

With reference to FIGS. 4-6, a second embodiment of a pipe coupling method 2 includes a first end seal 40, a second end seal 42, the clamping device 12, a tubular insert 44, forming a first bell flare 48 on an end of a first pipe 46 and a second bell flare 52 on an end of a second pipe 50. The first bell flare 48 includes a first expansion portion 54 and a first flare 56. The second bell flare 52 includes a second expansion 58 and a second flare 60. The first end seal 40 includes a first internal slot 62 that is sized to receive the first flare 56 of the first pipe 46. A first tapered surface 64 is also formed on the one side of the first end seal 40, substantially between the first internal slot 62 and an outer perimeter of the first end seal 40. A first inner perimeter 65 is formed through the first end seal 40 that is preferably the same size as the inner perimeter of the first and second expansion portions. At least one sealing projection 66 extends from the other side of the first end seal 40. The at least one sealing projection 66 provides a seal between the first and second end seals.

The second end seal 42 includes a second internal slot 70 that is sized to receive the second flare 60 on the one end of the second pipe 50. A second tapered surface 72 is also formed on the one side of the second end seal 42, substantially between the second internal slot 70 and an outer perimeter of the second end seal 42. A second inner perimeter 73 is formed through the second end seal 42 that is preferably the same size as the inner perimeter of the first and second pipes. It is preferable that the first and second flares be retained in the first and second internal slots with an adhesive and that the tubular member 44 be secured to one of the first and second pipes with adhesive.

The tubular insert 44 is sized to be received by the first and second expansion portions of the first and second pipes, respectively. An inner perimeter 76 of the tubular insert 44 is preferably the same size as the inner perimeters of the first and second pipes. The tubular insert 44 is preferably rolled into shape and not joined at the ends thereof. The unjoined ends form a narrow slot 80. However, the tubular insert 44 may be extruded or joined on the ends thereof with welding or any other suitable method.

An inner perimeter of each clamp ring half is sized to receive the first and second end seals. Closing the draw lever 26 forces the first pipe 46, the second pipe 50, the first end seal 40 and the second end seal 42 together. The addition of the tubular insert 44, the first end seal 40 and the second end seal 42 allows the junction between the first and second pipes to be sealed for vacuum as well as pressure applications.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of coupling two adjacent pipes, comprising the steps of:
forming a first flange on the end of a first pipe;
forming a second flange on the end of a second pipe;
providing an end seal that receives said first flange on a first end and said second flange on a second end; and
capturing an outer perimeter of said end seal with a clamp, forcing the first and second pipes together by closing said clamp.

2. The method of coupling two adjacent pipes of claim 1, further comprising the step of:
forming a first end seal and a second end seal from said end seal.

3. The method of coupling two adjacent pipes of claim 1, further comprising the step of:
forming a first internal slot in one end of said end seal to receive said first flange, forming a second internal slot in the other end of said end seal to receive said second flange.

4. The method of coupling two adjacent pipes of claim 2, further comprising the step of:
forming a first tapered surface on one end of said end seal, forming a second tapered surface on the other end of said end seal.

5. The method of coupling two adjacent pipes of claim 1, further comprising the step of:
forming an inner perimeter through said end seal.

6. The method of coupling two adjacent pipes of claim 2, further comprising the step of:
providing said clamp with a first clamp ring half, a second clamp ring half and a draw lever, one end of said first and second clamp ring halves being pivotally attached to each other, the other ends of said clamp ring halves being pulled together by closing said draw lever.

7. The method of coupling two adjacent pipes of claim 6, further comprising the step of:
providing said first and second clamp ring halves with a V-shaped cross section.

8. A method of coupling two adjacent pipes, comprising the steps of:
forming a first flange on the end of a first pipe;
forming a second flange on the end of a second pipe;
providing a first end seal that receives said first flange;
providing a second end seal that receives said second flange;
capturing an outer perimeter of said first and second end seals with a clamp, forcing the first and second pipes together by closing said clamp.

9. The method of coupling two adjacent pipes of claim 8, further comprising the step of:
forming a first internal slot in one end of said first end seal to receive said first flange, forming a second internal slot in one end of said second end seal to receive said second flange.

10. The method of coupling two adjacent pipes of claim 8, further comprising the step of:
forming a first tapered surface on one end of said first end seal, forming a second tapered surface on one end of said second end seal.

11. The method of coupling two adjacent pipes of claim 8, further comprising the step of:
forming a first inner perimeter through said first end seal, forming a second inner perimeter through said second end seal.

12. The method of coupling two adjacent pipes of claim 8, further comprising the step of:
providing said clamp with a first clamp ring half, a second clamp ring half and a draw lever, one end of said first and second clamp ring halves being pivotally attached to each other, the other ends of said clamp ring halves being pulled together by closing said draw lever.

13. The method of coupling two adjacent pipes of claim 12, further comprising the step of:
providing said first and second clamp ring halves with a V-shaped cross section.

14. The method of coupling two adjacent pipes of claim 8, further comprising the step of:
inserting a tubular insert into an inner perimeter of the first and second pipes.

15. The method of coupling two adjacent pipes of claim 14, further comprising the step of:
forming a first expansion portion in the first pipe and forming a second expansion portion in the second pipe to receive said tubular insert.

16. The method of coupling two adjacent pipes of claim 8, further comprising the step of:
extending at least one sealing projection from the other side of said first end seal.

17. A method of coupling two adjacent pipes, comprising the steps of:
forming a first flange on the end of a first pipe;
forming a second flange on the end of a second pipe;
providing an end seal that receives said first flange on a first end and said second flange on a second end;
forming a first tapered surface on the one end of said end seal, forming a second tapered surface on the other end of said end seal; and
capturing an outer perimeter of said end seal with a clamp, forcing the first and second pipes together by closing said clamp.

18. The method of coupling two adjacent pipes of claim 17, further comprising the step of:
forming a first end seal and a second end seal from said end seal.

19. The method of coupling two adjacent pipes of claim 17, further comprising the step of:
inserting a tubular insert into an inner perimeter of the first and second pipes.
